(19) United States
(12) Patent Application Publication
(10) Pub. No.: US 2008/0248807 A1
(43) Pub. Date: Oct. 9, 2008

(54) METHOD AND APPARATUS FOR CONTROLLING A CALL IN A COMMUNICATION SYSTEM

(75) Inventors: Ki-Back Kim, Seongnam-si (KR); Ju-Yong Lee, Suwon-si (KR); Dong-Soo Park, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/062,876

(22) Filed: Apr. 4, 2008

(30) Foreign Application Priority Data
Apr. 6, 2007 (KR) 34434-2007
Apr. 23, 2007 (KR) 39553-2007

(51) Int. Cl. H04Q 7/20

(52) U.S. Cl. 455/453

(57) ABSTRACT

A method for controlling a call, by a base station, in a communication system is provided. The method includes receiving a call admission request for call connection from a mobile station; determining whether to admit the call admission request taking into account a backhaul section capacity available in a backhaul section and a wireless section capacity available in a wireless section; and transmitting information indicating the determination result to the mobile station. The wireless section indicates a section between the base station and the mobile station, and the backhaul section indicates a section between the base station and a base station controller.

### PRIORITY

This application claims priority under 35 U.S.C. § 119(a) to a Korean Patent Application filed in the Korean Intellectual Property Office on Apr. 6, 2007 and assigned Serial No. 2007-34434, and a Korean Patent Application filed in the Korean Intellectual Property Office on Apr. 23, 2007 and assigned Serial No. 2007-39553, the disclosures of both of which are incorporated herein by reference.

### BACKGROUND OF THE INVENTION

1. Field of the Invention

The present invention relates generally to a call control method and apparatus in a communication system, and in particular, to a method and apparatus for controlling a call taking backhaul congestion into consideration in a communication system.

2. Description of the Related Art

In communication systems, realization of a call admission control function is indispensable to a delay request for real-time traffic and a band guarantee for non-real-time traffic, and the call admission control should be achieved on an end-to-end basis. The following description will be based on a Wireless Broadband Internet (WiBro) communication system, by way of example. The WiBro communication system may be roughly divided into a wireless section and a backhaul section on the basis of a base station or Radio Access Station (RAS).

In the following description, names of Network Entities (NEs) are defined according to their unique functions, and are subject to change according to the standard group and/or operators' intention. For example, a base station can be referred to as a Radio Access Station (RAS) or a Base Station (BS), and a base station controller can be referred to as an Access Control Router (ACR) or an Access Service Network-Gateway (ASN-GW). An ASN-GW can serve not only as the base station controller but also as a router.

FIG. 1 is a diagram illustrating a brief configuration of a general WiBro communication system.

Referring to FIG. 1, base station controllers 102 and 104 are each connected to an Internet Protocol (IP) network 110 and base stations 106 to 114. The base station controllers 102 and 104 are elements for communicating with mobile stations 116 to 122 through wireless interfaces at the end of a wired network. That is, the base station controllers 102 and 104 are elements for controlling the mobile stations 116 to 122 and the base stations 106 to 114, and routing IP packets. The base station controllers 102 and 104 inter-work with the base stations, manage mobility of the mobile stations, perform accounting and generation/notification of statistical information, provide Quality of Service (QoS) of the corresponding service, and perform authentication/security and wireless resource management/control. A backhaul section is formed between the base station controllers 102 and 104 and the base stations 106 to 114.

The base stations 106 to 114 each have a wireless section formed to the mobile stations 116 to 122 for subscribers' service reception. The base stations 106 to 114 perform call processing of setting up, maintaining and releasing a connection for a packet call, and handle handover, system control and interfacing of supplemental devices.

Various types of network configurations can be made in the backhaul section formed between the base station controllers 102 and 104, and the base stations 106 to 114. For example, the backhaul section can be composed of a wired network or a wireless network, or can include both the wire/wireless networks.

Generally, the capacity of the backhaul section is set higher than the capacity of the wireless section. However, when it is difficult to newly establish a backhaul section or the backhaul section's additional burden is considerable, the interface located just in front of the base stations 106 to 114 uses the existing network having the similar capacity to the average capacity of the wireless section. In this case, when a capacity change of the wireless section and an abnormal operation of the backhaul equipment occur, a congestion situation may occur. The congestion situation mainly occurs in the interface located just in front of the base station.

When the capacity of the backhaul section is sufficient, a bottleneck may occur, since the wireless capacity of a subcell assigned to each of the base stations 106 to 114 is not taken into consideration. Therefore, in order to prevent performance degradation for the entire flow of the corresponding subcell, call admission control should be performed on each subcell. However, when the backhaul section connected to an arbitrary base station suffers from bottleneck, the capacity of subcells for each corresponding base station is allocated, taking into account the capacity of the backhaul section connected to the base station. Similarly, consideration should be given to how to allocate the backhaul capacity to multiple subcells sharing the backhaul interface on a shared basis.

On the other hand, when the backhaul section is congested, the IP layer makes the most use of DiffServ based on DiffServ Code Point (DSCP) marking, and the Ethernet layer makes the most use of Ethernet CoS based on Class of Service (CoS) marking. That is, according to the priority of a call, the base station controller marks a 6-bit DSCP for the downlink and the base station marks a 6-bit DSCP for the uplink. The 6-bit DSCP marking is a scheme for protecting the high-priority traffic in the backhaul network by mapping the corresponding call traffic to a 3-bit CoS according to the priority. However, in the multi-level backhaul network structure, the section suffering from bottleneck cannot control the traffic according to the priority, causing a decrease in the throughput.

In the system based on the foregoing conventional technology, in order to determine whether to admit a call in units of base stations, the base station controller detects and manages the capacity of the backhaul section and the capacity of the wireless section separately for the corresponding base station. In this case, the backhaul section is composed of a complex network and the section suffering from bottleneck mainly occurs in front of the corresponding base station, making it difficult to detect the capacity of the backhaul section. In addition, in the backhaul section, connection of a link interface may fail or recovery of the failure may be more difficult, and when handover occurs, handover traffic occurring to the corresponding target base station should be taken into consideration. Therefore, the base station controller should have information on all situations of the backhaul section.

### SUMMARY OF THE INVENTION

An aspect of the present invention is to address at least the problems and/or disadvantages and to provide at least the advantages described below. Accordingly, an aspect of the present invention is to provide a method and apparatus for controlling a call in a communication system.

Another aspect of the present invention is to provide a method and apparatus for preventing performance degradation of all calls and probabilistically protecting performance of an individual call according to Quality of Service (QoS) priority, by controlling admission of a call taking into account congestions of both the wireless section and the backhaul section in a communication system.

Further another aspect of the present invention is to provide a method and apparatus in which a base station controls a call admission taking into account a capacity of a backhaul section and capacity of a wireless section, and when a failure that a link is unsatisfied with the capacity of the backhaul section occurs, releases a connected call or interrupts a service of the call.

Yet another aspect of the present invention is to provide a method and apparatus for increasing throughput of a section suffering from bottleneck in a multi-level backhaul network structure where priority-based control cannot be achieved.

According to one aspect of the present invention, there is provided a method for controlling a call by a base station in a communication system. The method includes receiving a call admission request for a call connection from a mobile station; determining whether to admit the call admission request taking into account a backhaul section capacity available in a backhaul section and a wireless section capacity available in a wireless section; and transmitting information indicating a determination result to the mobile station. The wireless section indicates a section between the base station and the mobile station, and the backhaul section indicates a section between the base station and a base station controller.

According to another aspect of the present invention, there is provided a method for controlling a call by a base station in a communication system. The method includes, upon receiving a call admission request for a call connection from a mobile station, determining whether at least one of a backhaul section's capacity change and a wireless section's capacity change exceeds a threshold, and when the at least one of the capacity changes exceeds the threshold, determining whether the at least one exceeding capacity change is negative or positive; and controlling services of service flows connected to the mobile station taking into account a backhaul section capacity available in a backhaul section and a wireless section capacity available in a wireless section. The wireless section indicates a section between the base station and the mobile station, and the backhaul section indicates a section between the base station and a base station controller.

According to further another aspect of the present invention, there is provided an apparatus for controlling a call in a communication system. The apparatus includes a call admission request receiver for receiving a call admission request for a call connection from a mobile station; a call controller for determining whether to admit the call admission request taking into account a backhaul section capacity available in a backhaul section and a wireless section capacity available in a wireless section; and a service status transmitter for transmitting information indicating a determination result to the mobile station under a control of the call controller. The wireless section indicates a section between a base station and the mobile station, and the backhaul section indicates a section between the base station and a base station controller.

According to yet another aspect of the present invention, there is provided an apparatus for controlling a call in a communication system. The apparatus includes a call admission request receiver for receiving a call admission request for a call connection from a mobile station; and a call controller for, when at least one of a backhaul section's capacity change and a wireless section's capacity change exceeds a threshold, determining whether the at least one exceeding capacity change is negative or positive, and controlling services of service flows connected to the mobile station, taking into account a backhaul section capacity available in a backhaul section and a wireless section capacity available in a wireless section. The wireless section indicates a section between a base station and the mobile station, and the backhaul section indicates a section between the base station and a base station controller.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating a brief configuration of a general WiBro communication system;

FIG. 2 is a flowchart for call admission control of a base station according to an embodiment of the present invention;

FIGS. 3A and 3B are flowcharts illustrating a call control operation of a base station according to different embodiments of the present invention; and

FIG. 4 is a block diagram illustrating a structure of a base station according to an embodiment of the present invention.

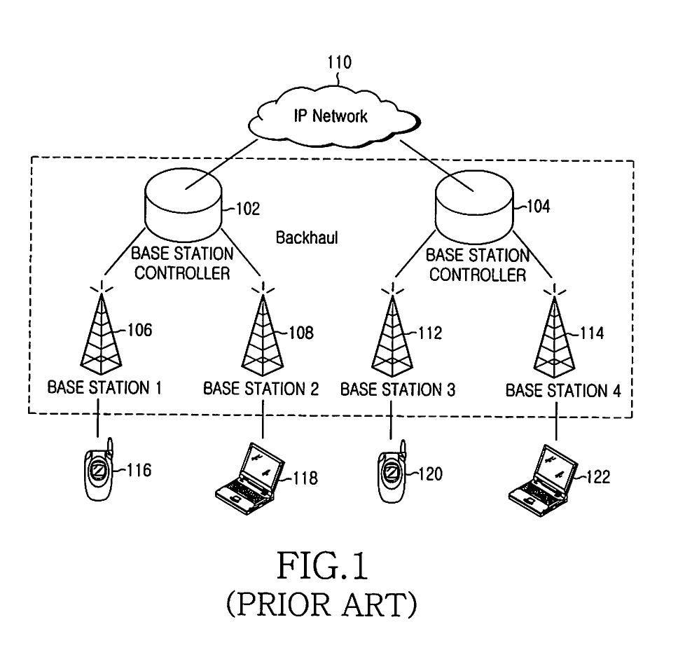

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness. Terms used herein are defined based on functions in the present invention and may vary according to users, operators' intention or usual practices. Therefore, the definition of the terms should be made based on contents throughout the specification.

A backhaul section formed between a base station controller and a base station can be composed of various types of networks. For call admission control in the backhaul section, all situations of the backhaul network should be taken into consideration, but this is actually impossible.

Therefore, a first embodiment of the present invention proposes a scheme for controlling a call admission taking into account a capacity change of the backhaul section connected to a corresponding base station and a capacity change of the wireless section connected to the corresponding base station, rather than taking the total capacity of the backhaul section into consideration.

When a call, for which an admission request for a call connection has been received from a mobile station, satisfies a condition of Equation (1), the base station admits the call.

A_{new}+Aₘ≦min{C_{BH}−A_{T},C_{A}−A_{T}} (1)

In Equation (1) C_{BH} denotes the total capacity of the backhaul section formed between the base station and the base station controller currently connected thereto, C_{A} denotes the total capacity of the wireless section between the base station and the mobile station connected thereto, A_{T} denotes a capacity of traffics currently connected to the base station, and A_{new} denotes a capacity of traffics of the admission-requested call. In addition, Aₘ is the minimum margin of the wireless capacity previously left over so that the base station can admit a call when an unexpected new call occurs due to handover and the like, and its value is predetermined. Aₘ can be designated and/or changed by the system operator.

That is, the base station admits the call when a sum A_{new}+Aₘ of the traffic capacity of the admission-requested call and the margin is less than or equal to the minimum value between the capacity C_{BH}−A_{T} currently available in the backhaul section and the capacity C_{A}−A_{T} currently available in the wireless section.

In this case, if the admission-requested call is not a traffic requiring Quality of Service (QoS), the call may have no direct influence on the current capacity of the backhaul section or wireless section, since it has low priority during base station scheduling. Therefore, the base station admits the non-QoS traffic call no matter whether it satisfies requirements of the backhaul section.

On the other hand, if the admission-requested call is a traffic requiring QoS, the base station admits the call only when it satisfies Equation (1).

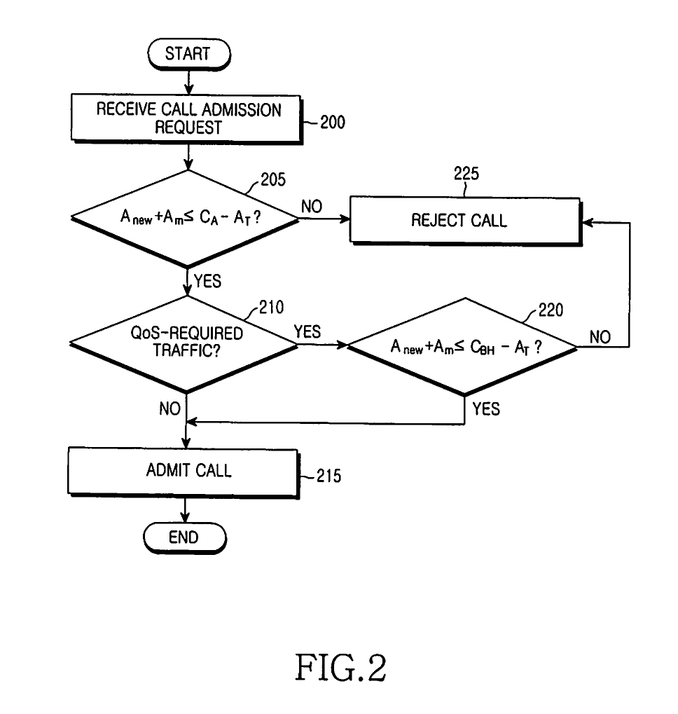

FIG. 2 is a flowchart for call admission control of a base station according to an embodiment of the present invention.

Referring to FIG. 2, in step 200, the base station receives an admission request for call connection from an arbitrary mobile station. In step 205, the base station determines whether a sum A_{new}+Aₘ of a traffic capacity of the admission-requested call and a margin is less than or equal to a capacity C_{A}−A_{T} of resources currently available in a wireless section. If it is determined that A_{new}+Aₘ is greater than C_{A}−A_{T}, the base station rejects the call admission request in step 225.

However, if it is determined that A_{new}+Aₘ is less than or equal to C_{A}−A_{T}, the base station determines, in step 210, whether a traffic of the call is a QoS-required traffic. If it is determined that the call traffic is not a QoS-required traffic, the base station admits the call in step 215.

However, if it is determined that the call traffic is a QoS-required traffic, the base station determines in step 220 whether A_{new}+Aₘ is less than or equal to a capacity C_{BH}−A_{T} currently available in a backhaul section. If it is determined that A_{new}+Aₘ is less than or equal to C_{BH}−A_{T}, the base station admits the call in step 215. However, if it is determined that A_{new}+Aₘ is greater than C_{BH}−A_{T}, the base station rejects the call admission request in step 225.

A link of a wire backhaul section, directly connected to the base station, can be composed of multiple T1 links or E1 links. In this case, if a connection of the corresponding link fails, the total capacity of the backhaul section is reduced. For example, when n T1 links are used, the total capacity of the backhaul section is calculated using Equation (2).

C_{BH}=n×(1.544 Mbps) (2)

If m T1 links are connection-failed in the backhaul section, the current remaining capacity C_{BH,fail} of the backhaul section whose capacity has been reduced through the connection-failed links, is calculated using Equation (3).

C_{BH,fail}=(n−m)×(1.544 MbPs) (3)

In addition, as to the total capacity of the backhaul section, a change in the wireless backhaul section is taken into consideration, in the base station.

A second embodiment of the present invention proposes a scheme in which, when there are failed links in connection to the wire backhaul section or when a capacity of the backhaul section is reduced due to a change in the capacity in the wireless backhaul section, a base station releases connection of a call or interrupts a service of the call in order of the lower-priority traffic among the currently connected calls. For each service flow, the priority varies according to the QoS policy.

For example, the priority can be represented in units of classes, including signaling, as defined in Equation (4).

Signaling>RT (Real-Time)>NRT (Non-Real-Time)>OAM (Operations, Administration, and Maintenance)>BE (Best Effort) (4)

When there are failed links in connection in the wire backhaul section or when the total capacity of the backhaul section is reduced due to a capacity change in the wireless backhaul section, the base station detects priorities of the currently connected calls using Equation (4). It is assumed herein that N calls currently connected to the base station are ordered according to their priorities. Aᵢ indicates an equivalent band of an i^{th} call, where i is a priority indicator. There are a total of N priority indicators, and when i=1, its priority is highest.

When a current change in the capacity (hereinafter, “capacity change”) of the backhaul section or a capacity change of the wireless section is greater than a predetermined threshold, the base station determines whether the capacity change of the backhaul section or the capacity change of the wireless section has increased or decreased from a reference amount of resources allocated to the existing system. If it is determined that the capacity change of the backhaul section or the wireless section has increased from the reference amount, the base station further includes a procedure for resuming the service after checking the interrupted service flow, when the currently available capacity of the backhaul section or the wireless section satisfies Equation (5).

When the interrupted (failed) link is recovered or the capacity of the wireless section has increased, the capacity change of the backhaul section increases. Thereafter, if the base station detects a congestion situation of the backhaul section or the wireless section according to a condition of Equation (5), the base station resolves the congestion situation by interrupting or releasing the corresponding service flow according to the following operation procedures #1 to #4.

$${\sum }_{i = 1}^{N} {A}_{i} + {A}_{m} < min \{ {C}_{{BH}_{remain}} , {C}_{A} \} \qquad ( 5 )$$

The base station, as shown in Equation (5), compares a total sum

$${\sum }_{i = 1}^{N} {A}_{i} + {A}_{m}$$

of a sum

$${\sum }_{i = 1}^{N} {A}_{i}$$

of capacities of the currently connected calls and a margin Aₘ of a wireless section capacity, predetermined by the base station, with a minimum value min {C_{BH}_{ᵣₑₘₐᵢₙ}, C_{A}} between a capacity change of a backhaul section of the base station and a capacity change of a wireless section of the base station. C_{BH}_{ᵣₑₘₐᵢₙ} denotes the current remaining capacity of the backhaul section whose total capacity has been reduced, since there are failed links in connection in the wire backhaul section or there is a capacity change in the wireless backhaul section. Specifically, the base station compares C_{BH}_{ᵣₑₘₐᵢₙ} with C_{A}, and if C_{BH}_{ᵣₑₘₐᵢₙ}≦C_{A}, determines whether

$${\sum }_{i = 1}^{N} {A}_{i} + {A}_{m} \leq {C}_{{BH}_{remain}}$$

according to Equation (5).

If it is determined that

$${\sum }_{i = 1}^{N} {A}_{i} + {A}_{m} > {C}_{{BH}_{remain} ,}$$

the determination result indicates that the backhaul section is now congested because the capacity of the backhaul section decreases due to the wire link failure or a change in the wireless environment. In this case, a Radio Frequency (RF) scheduler in the base station's modem cannot control a Transmission Control Protocol (TCP) service flow of a Best Effort (BE) service having a low priority. Therefore, the base station interrupts or releases the corresponding service flow according to an operation procedure #3 and an operation procedure #4. However, if it is determined that

$${\sum }_{i = 1}^{N} {A}_{i} + {A}_{m} \leq {C}_{{BH}_{remain} ,}$$

the base station, if there are interrupted service flows, resumes services of the corresponding service flows according to the QoS priorities of the interrupted service flows. In this case, the base station resumes services of the interrupted service flows so long as the capacity required for the resumed services does not exceed the backhaul capacity increased from a predetermined threshold.

Next, if it is determined that C_{BH}_{ᵣₑₘₐᵢₙ}>C_{A}, the base station determines whether

$${\sum }_{i = 1}^{N} {A}_{i} + {A}_{m}$$

is less than or equal to C_{A} according to Equation (5). If it is determined that

$${\sum }_{i = 1}^{N} {A}_{i} + {A}_{m}$$

is greater than C_{A}, it indicates a situation where the wireless section between the base station and the mobile station is congested. In this case, the RF scheduler of the base station controls a TCP service flow of a BE class and follows the following operation procedure #2, and a part other than the RF scheduler does not additionally perform service interrupt/release of the service flow. The following operation procedures #1 through #4 are detailed procedures in which the base station performs service interrupt/release and service resumption when a congestion situation of the wireless section or the backhaul section is detected through Equation (5).

Operation procedure #1: When a base station releases a call, the base station transmits information indicating the release of the call to a base station controller connected to the base station itself, so that the base station controller releases resources for the call.

Operation procedure #2: When the base station interrupts a service of an arbitrary service flow, the base station generates a life timer according to QoS of each corresponding service flow, and closes (disconnects) the call when the corresponding life timer expires.

Operation procedure #3: When the base station interrupts or resumes a service of a downlink service flow, the base station transmits information indicating the interrupt or resumption of the service of the corresponding service flow to the base station controller. Thereafter, base station controller interrupts the downlink traffic of the corresponding service flow or releases the connection according to the information. On the other hand, when the base station interrupts or resumes a service of an uplink service flow, the base station does not transmit service status-related information of the interrupted/resumed uplink service flow to the base station controller. In addition, when flow control including interrupt/resumption and release of a service flow occurs, every time a predetermined amount of traffic is reduced in the wireless section, the base station periodically transmits information indicating the reduction to the base station controller.

Operation procedure #4: When a congestion situation occurs in the backhaul section, an RF scheduler in the base station modem does not control the TCP-based BE service flow. In this case, according to the present invention, a traffic controller included in the base station, other than the RF scheduler, controls the BE service flow as follows.

Operation procedure #4-1: When the total sum of traffic capacities of the three types of classes—real-time Polling Service (rtPS), extended-real-time Polling Service (ertPS) and Unsolicited Grant Service (UGS)—included in a real-time service flow is greater than C_{BH}_{ᵣₑₘₐᵢₙ} as shown in Equation (6), the traffic controller interrupts or releases services of all service flows corresponding to non-real-time Polling Service (nrtPS) and BE service.

throughput of (rtPS+ertPS+UGS)>C_{BH}_{ᵣₑₘₐᵢₙ} (6)

Operation procedure #4-2: When the traffic controller satisfies Equation (6) but does not satisfy Equation (7), the traffic controller interrupts or releases services of all service flows corresponding to the BE service.

throughput of (nrtPS+rtPS+ertPS+UGS)>C_{BH}_{ᵣₑₘₐᵢₙ}>throughput of (rtPS+ertPS+UGS) (7)

Operation procedure #4-3: When the traffic controller satisfies Equation (8), it first protects the three types of classes included in the real-time service flow, and first protects nrtPS service flows for the remaining available capacity of the backhaul section. At this point, the traffic controller performs congestion control on the TCP-based service flow in the nrtPS service flow. Thereafter, the traffic controller performs congestion control on BE service flows for the remaining capacity.

throughput of (nrtPS+rtPS+ertPS+UGS)>C_{BH}_{ᵣₑₘₐᵢₙ} (8)

As an example of the operation procedure #4, the traffic controller calculates the currently available backhaul capacity C_{BH}_{ᵣₑₘₐᵢₙ} by subtracting the total throughput of the three types of classes of the real-time services from the current remaining backhaul capacity as shown in Equation (9).

C_{BH}_{_{backhaul}}=C_{BH}_{ᵣₑₘₐᵢₙ}−throughput of (UGS+ertPS+rtPS) (9)

Thereafter, for C_{BH}_{_{backhaul}}, the traffic controller sets a weight for each service class in a specific ratio. For example, a weight of the nrtPS service flow versus the BE service flow is set as 2:1. In this case, the nrtPS service flow uses ⅔ of the calculated C_{BH}_{_{backhaul}}, and the BE service flow uses ⅓ of C_{BH}_{_{backhaul}}.

Meanwhile, when the base station determines to perform a service interrupt for the corresponding service flow, the base station may include a method for interrupting the service after a life timer of the service flow expires according to the operation procedure #2 or adjusting the amount of traffic by assigning a weight for each service class as described above, in order to interrupt the service of the service flow.

When the congestion situation of the wireless section or the backhaul section is detected based on Equation (5) as described above, the base station interrupts the service flow of the call or releases the connection beginning from the call having the low-priority service class among the currently connected calls according to the foregoing operation procedures. When the connection of the corresponding call is released, the base station controller and the base station no longer manage the call.

However, when the service of the corresponding call is interrupted, the base station manages the call, but data transmission is interrupted for a service flow of the call. In this case, the user can release the corresponding call spontaneously.

The base station performs no control for the service-interrupted call. However, since the base station controller cannot recognize the occurrence of the service-interrupted call in the base station, it may continuously transmit traffic for the service-interrupted call to the base station. As a result, when no congestion control is performed in the backhaul network, the quality of even other calls may deteriorate. Therefore, according to the present invention, the base station performs the operation procedure #1 through the operation procedure #3.

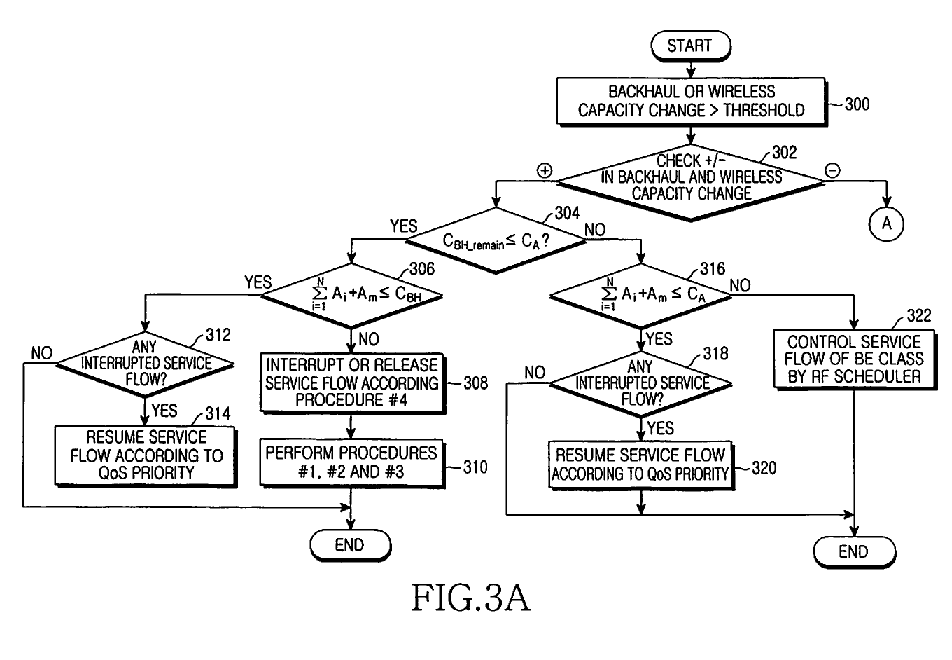

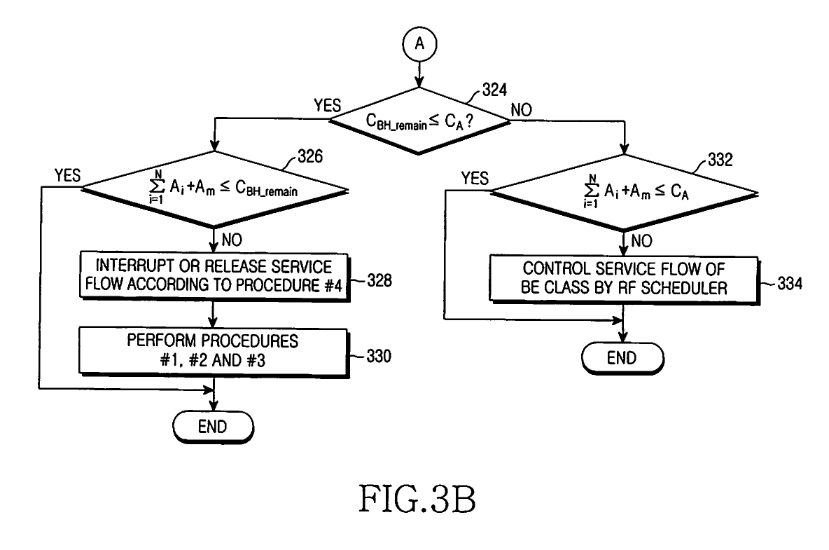

FIGS. 3A and 3B are flowcharts illustrating a call control operation of a base station according to different embodiments of the present invention.

Referring to FIG. 3A, in step 300, a base station allocates traffic after admission of a call request, and proceeds to step 302 when a capacity change of a backhaul section or a wireless section due to the traffic allocation exceeds a predetermined threshold.

In step 302, the base station determines whether the capacity change of the backhaul section and/or the wireless section has increased or decreased from a reference amount of resources allocated to the existing system. If it is determined that the capacity change has increased, the base station proceeds to step 304. However, if it is determined that the capacity change has decreased, the base station proceeds to step 324 (A). A procedure following step 324 (A) will be described in detail with reference to FIG. 3B.

In step 304, the base station compares C_{BH}_{_{backhaul}} with C_{A}, and if C_{BH}_{ᵣₑₘₐᵢₙ}≦C_{A}, the base station proceeds to step 306 where it determines whether

$${\sum }_{i = 1}^{N} {A}_{i} + {A}_{m} \leq {C}_{{BH}_{remain}}$$

according to Equation (5). If it is determined that

$${\sum }_{i = 1}^{N} {A}_{i} + {A}_{m} > {C}_{{BH}_{remain}} ,$$

the base station proceeds to step 308 since the backhaul section is now congested as the capacity of the backhaul section has decreased due to the wire link failure or a change in the wireless environment. In step 308, the base station interrupts or releases a service of the corresponding service flow according to the operation procedure #4. In step 310, the base station performs the operation procedure #1 when the connection of the corresponding service flow is released, and performs the operation procedure #2 or #3 according to the corresponding requirements when the corresponding service is interrupted.

However, if it is determined in step 306 that

$${\sum }_{i = 1}^{N} {A}_{i} + {A}_{m} \leq {C}_{{BH}_{remain}} ,$$

the base station determines in step 312 whether there are any service-interrupted service flows. If it is determined that there are service-interrupted service flows, the base station sequentially resumes in step 314 the interrupted service flows according to their QoS priorities so long as the capacity required for the resumed services does not exceed the backhaul capacity increased from the threshold in step 300. However, if it is determined that there is no service-interrupted service flow, the operation of the base station ends.

However, if it is determined in step 304 that C_{BH}_{ᵣₑₘₐᵢₙ}>C_{A}, the base station proceeds to step 316 where it determines whether

$${\sum }_{i = 1}^{N} {A}_{i} + {A}_{m} \leq {C}_{A}$$

according to Equation (5). If it is determined that

$${\sum }_{i = 1}^{N} {A}_{i} + {A}_{m} > {C}_{A} ,$$

the base station proceeds to step 322 since the wireless resource between the base station and a mobile station is in a congestion situation. In step 322, an RF scheduler of the base station interrupts a BE service flow. For the service interrupt, the RF scheduler follows the operation procedure #2.

However, if it is determined in step 316 that

$${\sum }_{i = 1}^{N} {A}_{i} + {A}_{m} \leq {C}_{A} ,$$

the base station determines in step 318 whether there are any interrupted service flows. If it is determined that there are interrupted service flows, the base station resumes in step 324 services of the interrupted service flows according to their QoS priorities so long as the capacity required for the resumed services does not exceed the wireless capacity increased from the threshold in step 300. However, if it is determined that there is no interrupted service flow, the operation of the base station ends.

Referring to FIG. 3B, if it is determined in step 302 that the capacity change of the backhaul section and/or the wireless section has decreased from the reference amount of resources allocated to the existing system, the base station proceeds to step 324 (A).

In step 324, the base station compares C_{BH}_{ᵣₑₘₐᵢₙ} with C_{A}, and if C_{BH}_{ᵣₑₘₐᵢₙ}≦C_{A}, the base station proceeds to step 326 where it determines whether

$${\sum }_{i = 1}^{N} {A}_{i} + {A}_{m} \leq {C}_{{BH}_{remain}}$$

according to Equation (5). If it is determined that

$${\sum }_{i = 1}^{N} {A}_{i} + {A}_{m} > {C}_{{BH}_{remain}} ,$$

the base station proceeds to step 328 since the backhaul section is now in the congestion situation as the capacity of the backhaul section has decreased due to the wire link failure or a change in the wireless environment.

In step 328, the base station interrupts or releases a service of the corresponding service flow according to the operation procedure #4. In step 330, the base station performs the operation procedure #1 when the connection of the corresponding service flow is released, and performs the operation procedure #2 or #3 according to the corresponding requirements when the service of the corresponding service is interrupted.

However, if it is determined in step 326 that

$${\sum }_{i = 1}^{N} {A}_{i} + {A}_{m} \leq {C}_{{BH}_{remain}} ,$$

the operation of the base station ends.

However, if it is determined in step 324 that C_{BH}_{ᵣₑₘₐᵢₙ}>C_{A}, the base station proceeds to step 332 where it determines whether

$${\sum }_{i = 1}^{N} {A}_{i} + {A}_{m} \leq {C}_{A}$$

according to Equation (5). If it is determined that

$${\sum }_{i = 1}^{N} {A}_{i} + {A}_{m} > {C}_{A} ,$$

the base station proceeds to step 334 since the wireless section is in the congestion situation. In step 334, the RF scheduler of the base station controls the service flow in the BE class, and then ends the operation.

However, if it is determined that

$${\sum }_{i = 1}^{N} {A}_{i} + {A}_{m} \leq {C}_{A} ,$$

the base station ends its operation.

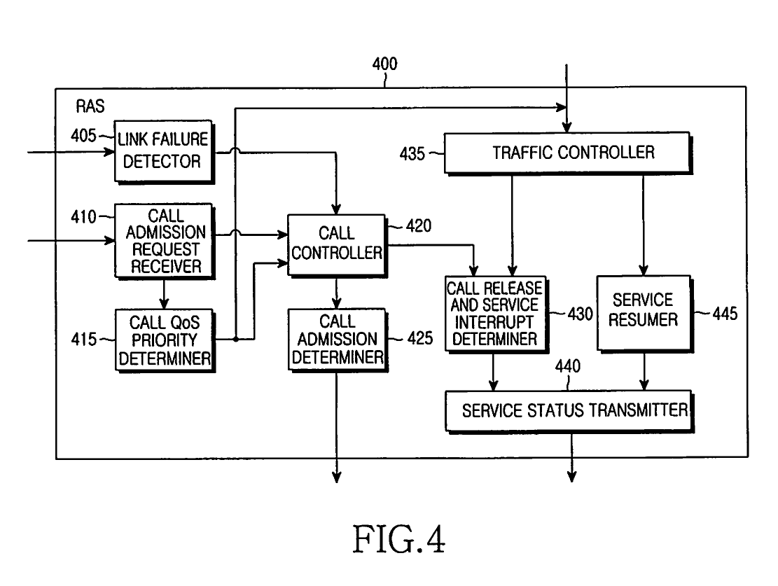

FIG. 4 is a block diagram illustrating a structure of a base station according to an embodiment of the present invention.

Referring to FIG. 4, a base station 400 includes a link failure detector 405, a call admission request receiver 410, a call QoS priority determiner 415, a call controller 420, a call admission determiner 425, a call release and service interrupt determiner 430, a traffic controller 435, a service status transmitter 440, and a service resumer 445.

Upon receiving a call admission request for requesting a connection from a mobile station, the call admission request receiver 410 forwards the call admission request to the call QoS priority determiner 415 and the call controller 420.

The call QoS priority determiner 415 determines whether the call is QoS-required traffic, and if the call is QoS-required traffic, the call QoS priority determiner 415 determines a priority of the call according to Equation (4) and delivers the determined priority to the call controller 420.

When an equivalent bandwidth, i.e., capacity, of the call satisfies a condition of Equation (1), i.e., satisfies both the current capacity of the wireless section and the current capacity of the backhaul section, the call controller 420 generates admission decision information indicating the admission of the call and delivers the admission decision information to the call admission determiner 425. When the capacity of the call cannot satisfy the condition of Equation (1), the call controller 420 generates admission decision information indicating the rejection of the call, and delivers the admission decision information to the call admission determiner 425.

The call admission determiner 425 connects or releases the corresponding call according to the decision information received from the call controller 420. The link failure detector 405 detects links, whose connection to the corresponding mobile station has failed in the backhaul section, and delivers information regarding the failed links to the call controller 420.

The traffic controller 435 compares a capacity change of the backhaul section and/or the wireless section with a predetermined threshold, and if the capacity change is greater than the threshold, the traffic controller 435 determines whether the capacity of the backhaul section and/or the wireless section has increased or decreased from a reference amount of resources allocated to the existing system, and delivers the results to the call release and service interrupt determiner 430 and the service resumer 445.

The traffic controller 435 compares and selects a smaller or C_{BH}_{ᵣₑₘₐᵢₙ} and C_{A}, and determines whether they satisfy a condition of Equation (5), i.e., determines whether the backhaul section or the wireless section is in a congestion situation. In the case where C_{BH}_{ᵣₑₘₐᵢₙ} is selected, if

$${\sum }_{i = 1}^{N} {A}_{i} + {A}_{m}$$

does not satisfy the condition of Equation (5), the traffic controller 435 determines to interrupt or release the corresponding flow according to the operation procedure #4, and then delivers the resulting information to the call release and service interrupt determiner 430.

In the case when

$${\sum }_{i = 1}^{N} {A}_{i} + {A}_{m}$$

satisfies the condition of Equation (5) and the capacity change of the backhaul section or the wireless section has increased, if there are interrupted service flows, the traffic controller 435 resumes the corresponding service flows according to their QoS priorities so long as the capacity required for the resumed services does not exceed the backhaul capacity increased from the threshold.

The call release and service interrupt determiner 430, under the control of the traffic controller 435, interrupts or releases the corresponding flow by performing the operation procedure #4, and delivers the result to the service status transmitter 440.

The service status transmitter 440 provides service status information of the service flow, received from the call release and service interrupt determiner 430 or the service resumer 445, to the base station controller according to the operation procedure #1 through the operation procedure #3.

In the case where C_{A} is selected, if

$${\sum }_{i = 1}^{N} {A}_{i} + {A}_{m}$$

does not satisfy the condition of Equation (5), the traffic controller 435 controls a TCP service flow of the BE class by means of an RF scheduler in the modem (not illustrated). Therefore, a part other than the RF scheduler does not perform service interrupt/release. For the service interrupt, the traffic controller 435 follows the operation procedure #2.

As is apparent from the foregoing description, the present invention controls admission/rejection of admission-requested calls taking into account both the capacity of the wireless section and the capacity of the backhaul section in units of base stations, making it possible to reduce a load of the base station controller and to efficiently control the call admission through monitoring of the status of the links connected to the base station. In addition, when the connection of a link of the base station fails, the present invention performs scheduling according to the QoS traffic priority of the corresponding call, thereby making it possible to protect the high-priority call.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for controlling a call by a base station in a communication system, the method comprising:
receiving a call admission request for a call connection from a mobile station;
determining whether to admit the call admission request, taking into account a backhaul section capacity available in a backhaul section and a wireless section capacity available in a wireless section; and
transmitting information indicating a determination result to the mobile station, wherein the wireless section indicates a section between the base station and the mobile station, and the backhaul section indicates a section between the base station and a base station controller.

2. The method of claim 1, wherein the determining comprises:
determining whether one of the wireless section capacity and the backhaul section capacity can be allocated according to a traffic capacity of the call, wherein the determining includes:
comparing a sum of the traffic capacity of the call and a margin of the wireless section capacity with the wireless section capacity;
when the sum is less than or equal to the wireless section capacity and a traffic of the call is a traffic of a Quality of Service (QoS)-required service class, comparing the sum with the backhaul section capacity; and
when the sum is less than or equal to the backhaul section capacity, determining to admit the call admission request.

3. The method of claim 2, wherein when a new call occurs, the margin is a capacity allocated to admit a call admission request for the new call.

4. A method for controlling a call by a base station in a communication system, the method comprising:
upon receiving a call admission request for a call connection from a mobile station, determining whether at least one of a backhaul section's capacity change and a wireless section's capacity change exceeds a threshold, and when the at least one of the capacity changes exceeds the threshold, determining whether the at least one exceeding capacity change is negative or positive; and
controlling services of service flows connected to the mobile station taking into account a backhaul section capacity available in a backhaul section and a wireless section capacity available in a wireless section;
wherein the wireless section indicates a section between the base station and the mobile station, and the backhaul section indicates a section between the base station and a base station controller.

5. The method of claim 4, wherein the controlling comprises:
when the at least one exceeding capacity change is positive and the backhaul section capacity is less than or equal to the wireless section capacity, determining whether one of the wireless section capacity and the backhaul section capacity can be allocated according to a traffic capacity of the call, wherein the determining includes:
comparing a sum of the traffic capacity of the call and a margin of the wireless section capacity with the backhaul section capacity; and
sequentially resuming services of corresponding service flows according to priorities of service classes of the services, when the sum is less than or equal to the backhaul section capacity and there are service-interrupted service flows.

6. The method of claim 5, wherein when a new call occurs, the margin is a capacity allocated to admit a call admission request for the new call.

7. The method of claim 6, further comprising:
when the sum exceeds the backhaul section capacity, determining a service interrupt or a service release for a corresponding service flow according to a priority of a service class for each of currently connected service flows.

8. The method of claim 7, further comprising:
when a determination result indicates the service release for the corresponding service flow, transmitting information indicating the service release for the corresponding service flow to the base station controller.

9. The method of claim 7, further comprising:
when a determination result indicates service interrupt for the corresponding service flow, starting a timer, and when the timer expires, interrupting a service of the corresponding service flow.

10. The method of claim 7, further comprising:
when a determination result indicates the service interrupt for the corresponding service flow, interrupting a service of the corresponding service flow using a capacity weight predetermined for each service class's priority.

11. The method of claim 4, wherein the controlling comprises:
determining allocate one of the wireless section capacity and the backhaul section capacity can be allocated according to the traffic capacity of the call, when the backhaul section capacity exceeds the wireless section capacity, wherein the determining includes:
comparing a sum of the traffic capacity of the call and a margin of the wireless section capacity with the wireless section capacity; and
sequentially resuming services of corresponding service flows according to priorities of service classes of the services, when the sum is less than or equal to the backhaul section capacity and there are service-interrupted service flows.

12. The method of claim 11, wherein when a new call occurs, the margin is a capacity allocated to admit a call admission request for the new call.

13. The method of claim 12, further comprising:
when the sum exceeds the wireless section capacity, controlling a service of a service flow having a lowest priority of the service class.

14. The method of claim 4, wherein the controlling comprises:
when the at least one exceeding capacity change is negative, the backhaul section capacity is less than or equal to the wireless section capacity, and a sum of the traffic capacity of the call and a margin of the wireless section capacity exceeds the backhaul section capacity, determining a service interrupt or a service release for a corresponding service flow according to a priority of a service class for each of currently connected service flows.

15. The method of claim 14, further comprising:
when a determination result indicates the service release for the corresponding service flow, transmitting information indicating the service release for the corresponding service flow to the base station controller.

16. The method of claim 14, further comprising:
when determination result indicates service interrupt for the corresponding service flow, starting a timer, and when the timer expires, interrupting a service of the corresponding service flow.

17. The method of claim 14, further comprising:
when a determination result indicates the service interrupt for the corresponding service flow, interrupting a service of the corresponding service flow using a capacity weight predetermined for each service class's priority.

18. The method of claim 14, further comprising:
when the at least one exceeding capacity change is negative, the backhaul section capacity exceeds the wireless section capacity, and the sum of the traffic capacity of the call and the margin of the wireless section capacity exceeds the wireless section capacity, controlling a service of a service flow having a lowest priority of the service class.

19. An apparatus for controlling a call in a communication system, the apparatus comprising:
a call admission request receiver for receiving a call admission request for a call connection from a mobile station;
a call controller for determining whether to admit the call admission request, taking into account a backhaul section capacity available in a backhaul section and a wireless section capacity available in a wireless section; and
a service status transmitter for transmitting information indicating a determination result to the mobile station under a control of the call controller, wherein the wireless section indicates a section between a base station and the mobile station, and the backhaul section indicates a section between the base station and a base station controller.

20. The apparatus of claim 19, wherein the call controller:
determines whether one of the wireless section capacity and the backhaul section capacity can be allocated according to a traffic capacity of the call, and compares a sum of the traffic capacity of the call and a margin of the wireless section capacity with the wireless section capacity; and
when the sum is less than or equal to the wireless section capacity and a traffic of the call is a traffic of a Quality of Service (QoS)-required service class, compares the sum with the backhaul section capacity, and when the sum is less than or equal to the backhaul section capacity, determines to admit the call admission request.

21. The apparatus of claim 20, wherein, when a new call occurs, the margin is a capacity allocated to admit a call admission request for the new call.

22. An apparatus for controlling a call in a communication system, the apparatus comprising:
a call admission request receiver for receiving a call admission request for a call connection from a mobile station; and
a call controller for, when at least one of a backhaul section's capacity change and a wireless section's capacity change exceeds a threshold, determining whether the at least one exceeding capacity change is negative or positive, and controlling services of service flows connected to the mobile station, taking into account a backhaul section capacity available in a backhaul section and a wireless section capacity available in a wireless section;
wherein the wireless section indicates a section between a base station and the mobile station, and the backhaul section indicates a section between the base station and a base station controller.

23. The apparatus of claim 22, wherein the call controller:
when the at least one exceeding capacity change is positive and the backhaul section capacity is less than or equal to the wireless section capacity, determines whether one of the wireless section capacity and the backhaul section capacity can be allocated according to a traffic capacity of the call; and
when the sum is less than or equal to the backhaul section capacity and there are service-interrupted service flows, compares a sum of the traffic capacity of the call and a margin of the wireless section capacity with the backhaul section capacity, and sequentially resumes services of corresponding service flows according to priorities of service classes of the services.

24. The apparatus of claim 23, wherein when a new call occurs, the margin is a capacity allocated to admit a call admission request for the new call.

25. The apparatus of claim 24, wherein when the sum exceeds the backhaul section capacity, the call controller determines a service interrupt or a service release for a corresponding service flow according to priority of a service class for each of currently connected service flows.

26. The apparatus of claim 25, further comprising:
when a determination result indicates the service release for the corresponding service flow, a service status transmitter for transmitting information indicating the service release for the corresponding service flow to the base station controller depending on the determination result received from the call controller.

27. The apparatus of claim 25, further comprising:
a call release and service interrupt determiner for, when the determination result indicates the service interrupt for the corresponding service flow, starting a timer under a control of the call controller when the determination result indicates the service interrupt for the corresponding service flow, and when the timer expires interrupting a service of the corresponding service flow.

28. The apparatus of claim 25, further comprising:
when a determination result indicates the service interrupt for the corresponding service flow, a call release and service interrupt determiner for interrupting a service of the corresponding service flow using a capacity weight predetermined for each service class's priority under a control of the call controller.

29. The apparatus of claim 22, wherein the call controller:
when the backhaul section capacity exceeds the wireless section capacity, determines whether one of the wireless section capacity and the backhaul section capacity can be allocated according to a traffic capacity of the call, compares a sum of the traffic capacity of the call and a margin of the wireless section capacity with the wireless section capacity, and when the sum is less than or equal to the backhaul section capacity and there are service-interrupted service flows, determines to sequentially resume services of corresponding service flows according to priorities of service classes of the services;
wherein the apparatus further comprises a service resumer for sequentially resuming services of the service flows under a control of the call controller.

30. The apparatus of claim 29, wherein when a new call occurs, the margin is a capacity allocated to admit a call admission request for the new call.

31. The apparatus of claim 30, wherein when the sum exceeds the wireless section capacity, the call controller controls a service of a service flow having a lowest priority of the service class.

32. The apparatus of claim 30, wherein when the at least one exceeding capacity change is negative, the backhaul section capacity is less than or equal to the wireless section capacity, and a sum of the traffic capacity of the call and a margin of the wireless section capacity exceeds the backhaul section capacity, the call controller determines a service interrupt or a service release for a corresponding service flow according to a priority of a service class for each of currently connected service flows.

33. The apparatus of claim 32, further comprising:
a service status transmitter for, when a determination result indicates the service release for the corresponding service flow, transmitting information indicating the service release for the corresponding service flow to the base station controller under the control of the call controller.

34. The apparatus of claim 32, further comprising:
a call release and service interrupt determiner for, when a determination result indicates the service interrupt for the corresponding service flow, starting a timer under the control of the call controller, and when the timer expires, interrupting a service of the corresponding service flow.

35. The apparatus of claim 32, further comprising:
a call release and service interrupt determiner for, when a determination result indicates service interrupt for the corresponding service flow, interrupting the service of the corresponding service flow using a capacity weight predetermined for each service class's priority under the control of the call controller.

36. The apparatus of claim 32, wherein when the at least one exceeding capacity change is negative, the backhaul section capacity exceeds the wireless section capacity, and the sum of the traffic capacity of the call and the margin of the wireless section capacity exceeds the wireless section capacity, the call controller controls a service of a service flow having a lowest priority of the service class.
